(19) United States
(12) Patent Application Publication
(10) Pub. No.: US 2025/0083763 A1
(43) Pub. Date: Mar. 13, 2025

(54) BICYCLE HANDLEBAR SYSTEM WITH CABLE ROUTING PATHWAY

(71) Applicant: TIEN HSIN INDUSTRIES CO., LTD., Taichung City (TW)

(72) Inventor: FONG-SYUAN GU, Taichung City (TW)

(73) Assignee: TIEN HSIN INDUSTRIES CO., LTD., Taichung City (TW)

(21) Appl. No.: 18/465,944

(22) Filed: Sep. 12, 2023

(51) Int. Cl. B62J 11/13; B62K 21/12

(52) U.S. Cl. CPC B62J 11/13; B62K 21/12

(57) ABSTRACT

A bicycle handlebar system with a cable routing pathway includes a stem having a cable routing space therein. A distal end of the stem has a handlebar connecting portion, which has two first clamping portions engaged with two second clamping portions of a clamping member. A position of the cable routing space facing the handlebar connecting portion has an entrance. A middle of the clamping member has an opening. A handlebar is clamped and fixed by the second clamping portions and the first clamping portions. Two parts of the handlebar being clamped are defined as two clamped surfaces. A part of the handlebar between the clamped surfaces has at least one cable routing pathway. When the stem is engaged with a steerer tube of a fork of a bicycle, a cable passes through the opening and the cable routing pathway to enter the cable routing space for hiding.

### BACKGROUND OF THE INVENTION

### Technical Field

The present disclosure relates generally to a handlebar system, and more particularly to a bicycle handlebar system with a cable routing pathway.

### Description of Related Art

For the sake of appearance and safety, an entrance and an exit that respectively communicate with a cavity inside a bicycle body are provided on the bicycle body of a conventional bicycle, so that a cable of a derailleur or a cable of a brake could be hidden within the bicycle body by passing through the exit and the entrance, thereby providing a better appearance and preventing the cable from protruding too much out of the bicycle body, which might cause danger due to the cable being hooked by foreign objects.

Although the conventional bicycle is designed to hide the cable, a stem handlebar of the bicycle endures repeated pressures applied by a user during riding the bicycle. If only a through hole is provided on a handlebar for the cable to pass through without reinforcing the strength of a periphery of the through hole, the strength of the periphery of the through hole would be diminished and the periphery of the through hole might be easily bent, when riding the bicycle. As a result, the stem handlebar should not be provided only with the through hole, which hides the cable of the stem handlebar inside the stem handlebar of the bicycle body.

### BRIEF SUMMARY OF THE INVENTION

In view of the above, the primary objective of the present disclosure is to provide a bicycle handlebar system, wherein two passageways that are opposite to each other are disposed on a stem body of a stem and a clamping member, respectively, and a cable routing pathway that communicates between the two opposite passageways is formed on a part of a handlebar, which is clamped between the stem body and the clamping member, so that a cable is hidden in the stem without being exposed; two sides of the handlebar having the cable routing pathway are clamped by the stem, thereby increasing the strength the handlebar and preventing the handlebar from being easily damaged by external forces.

The present disclosure provides a bicycle handlebar system with a cable routing pathway, including a stem and a handlebar engaged with the stem; the stem extends along a first axial direction; two opposite ends of the first axial direction are respectively defined as a distal end and a proximal end.

The stem includes a stem body and a clamping member; the proximal end of the stem body has a fork connecting portion; the distal end of the stem body has a handlebar connecting portion; the stem body has a cable routing space therein, wherein a position of the cable routing space facing the handlebar connecting portion has an entrance, and a position of the cable routing space adjacent to the fork connecting portion has an exit; two opposite sides of the handlebar connecting portion in a direction perpendicular to the first axial direction respectively have a first clamping portion; the entrance is formed between the two first clamping portions; the clamping member is detachably engaged with the handlebar connecting portion; two opposite sides of the clamping member in the direction perpendicular to the first axial direction respectively have a second clamping portion; the two second clamping portions are opposite to the two first clamping portions in the first axial direction; a part of the clamping member located between the two second clamping portions has an opening.

The handlebar is clamped between the handlebar connecting portion and the clamping member; two parts of an outer surface of the handle, which are clamped between the two first clamping portions and the two second clamping portions, are defined as two clamped surfaces; a part of the handlebar located between the two clamped surfaces has at least one cable routing pathway, wherein the at least one cable routing pathway communicates between the opening and the entrance.

When the present disclosure is used, the fork connecting portion of the stem is engaged with a steerer tube of a fork of a bicycle, and a brake lever or a gearshift lever are installed on the handlebar. With the aforementioned design, the effect of the present disclosure is that the cables connected to the brake lever or the cables connected to the gearshift lever could pass through the opening, the at least one cable routing pathway, the cable routing space, and the exit of the cable routing space, so that the cables are hidden in the stem, thereby achieving the effect of providing a better appearance upon hiding the cables on the stem and preventing the cables on the stem from being protruding too much out of the bicycle body, which might causes danger due to the cables being hooked by foreign objects. Additionally, the two sides of the handlebar having the at least one cable routing pathway are tightly clamped by the two first clamping portions and the two second clamping portions, so that the part of the handlebar having the at least one cable routing pathway could be fixed without being easily bent, thereby increasing the strength of the part the handlebar having the at least one cable routing pathway and preventing the handlebar from being easily damaged by external forces when the strength of the part of the handlebar having the at least one cable routing pathway is decreased due to the formation of the at least one cable routing pathway.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1 is a perspective view of the bicycle handlebar system with the cable routing pathway according to a first embodiment of the present disclosure;

FIG. 2 is an exploded view of the bicycle handlebar system with the cable routing pathway according to the first embodiment of the present disclosure;

FIG. 3 is a front view of the bicycle handlebar system with the cable routing pathway according to the first embodiment of the present disclosure;

FIG. 4 is a bottom view of the bicycle handlebar system with the cable routing pathway according to the first embodiment of the present disclosure;

FIG. 5 is a top view of the bicycle handlebar system with the cable routing pathway according to the first embodiment of the present disclosure;

FIG. 6 is a sectional view along the F6-F6 line in FIG. 5;

FIG. 7 is a right side view of the bicycle handlebar system with the cable routing pathway according to the first embodiment of the present disclosure;

FIG. 8 is a sectional view along the F8-F8 line in FIG. 7;

FIG. 9 is an exploded view of the bicycle handlebar system with the cable routing pathway according to a second embodiment of the present disclosure;

FIG. 10 is a front view of the bicycle handlebar system with the cable routing pathway according to the second embodiment of the present disclosure;

FIG. 11 is a sectional view along the F11-F11 line in FIG. 10;

FIG. 12 is an exploded view of the bicycle handlebar system with the cable routing pathway according to a third embodiment of the present disclosure;

FIG. 13 is a front view of the bicycle handlebar system with the cable routing pathway according to the third embodiment of the present disclosure;

FIG. 14 is a sectional view along the F14-F14 line in FIG. 13;

FIG. 15 is an exploded view of the bicycle handlebar system with the cable routing pathway according to a fourth embodiment of the present disclosure;

FIG. 16 is a front view of the bicycle handlebar system with the cable routing pathway according to the fourth embodiment of the present disclosure;

FIG. 17 is a sectional view along the F17-F17 line in FIG. 16;

FIG. 18 is a perspective view of the bicycle handlebar system with the cable routing pathway according to a fifth embodiment of the present disclosure;

FIG. 19 is an exploded view of the bicycle handlebar system with the cable routing pathway according to the fifth embodiment of the present disclosure;

FIG. 20 is a top view of the bicycle handlebar system with the cable routing pathway according to the fifth embodiment of the present disclosure;

FIG. 21 is a sectional view along the F21-F21 line in FIG. 20;

FIG. 22 is a right side view of the bicycle handlebar system with the cable routing pathway according to the fifth embodiment of the present disclosure; and

FIG. 23 is a sectional view along the F23-F23 line in FIG. 22.

### DETAILED DESCRIPTION OF THE INVENTION

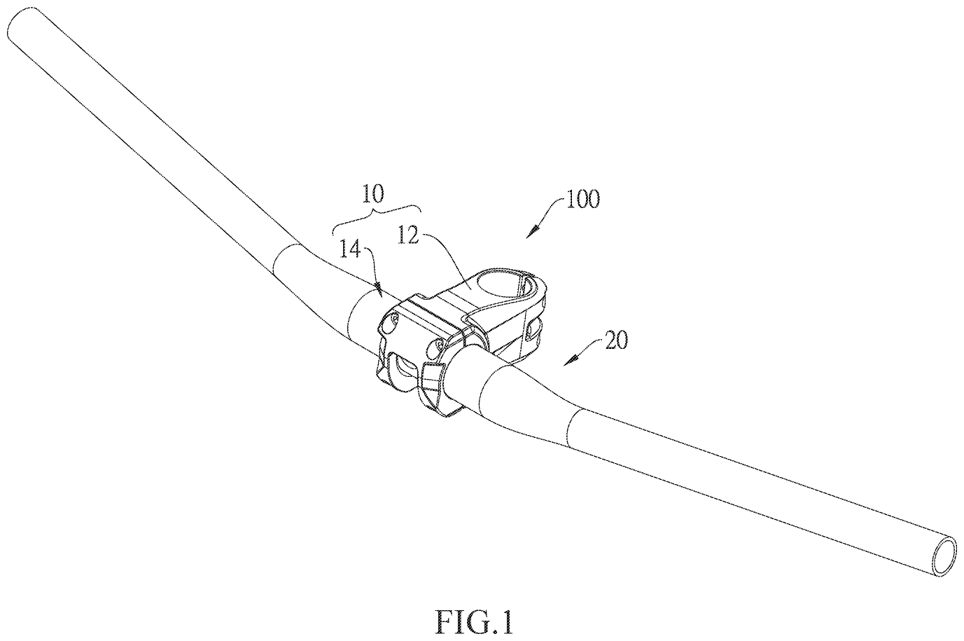

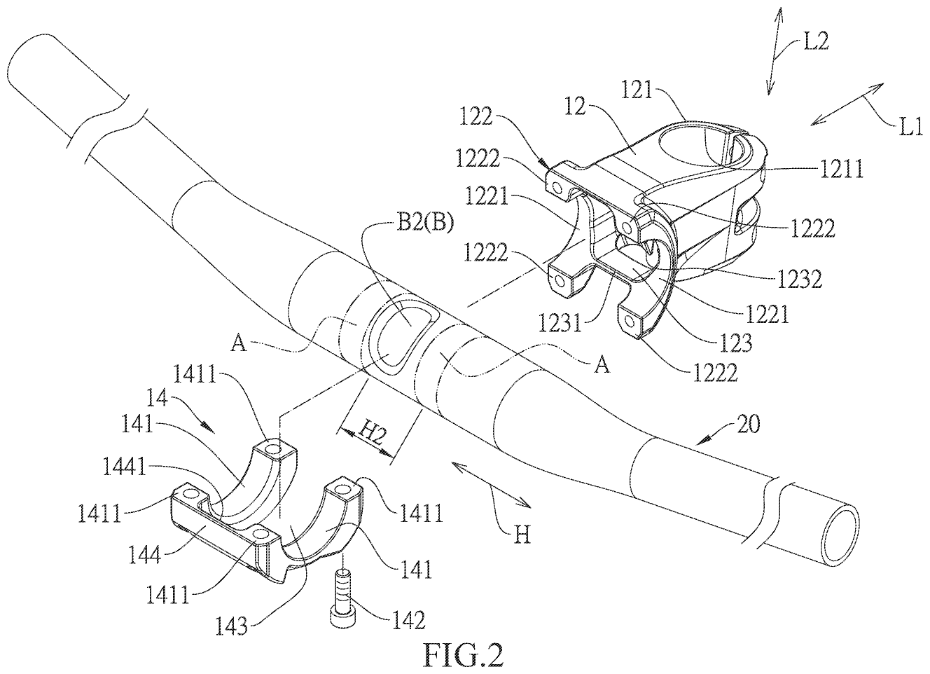

A bicycle handlebar system with a cable routing pathway 100 according to a first embodiment of the present disclosure is illustrated in FIG. 1 to FIG. 2 and includes a stem 10 and a handlebar 20 engaged with the stem 10. The stem 10 extends along a first axial direction L1. Two opposite ends of the first axial direction L1 are respectively defined as a distal end and a proximal end. The handlebar 20 extends along a third axial direction H. In the first embodiment, the third axial direction H is approximately perpendicular to the first axial direction L1.

Referring to FIG. 2, the stem 10 includes a stem body 12 and a clamping member 14. The stem body 12 is a tube that extends substantially along the first axial direction L1, wherein a proximal end of the stem body 12 has a fork connecting portion 121, and a distal end of the stem body 12 has a handlebar connecting portion 122. The fork connecting portion 121 is a clamp adapted to clamp and fix a steerer tube of a fork of a bicycle. The fork connecting portion 121 has a fork connecting hole 1211 extending along a second axial direction L2. Two opposite sides of the second axial direction L2 are respectively defined as a first side and a second side.

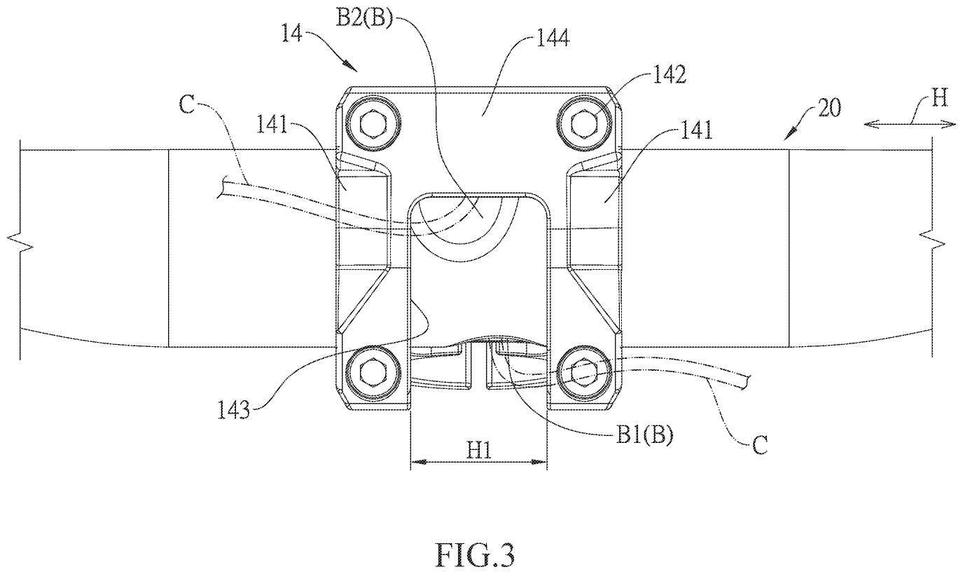

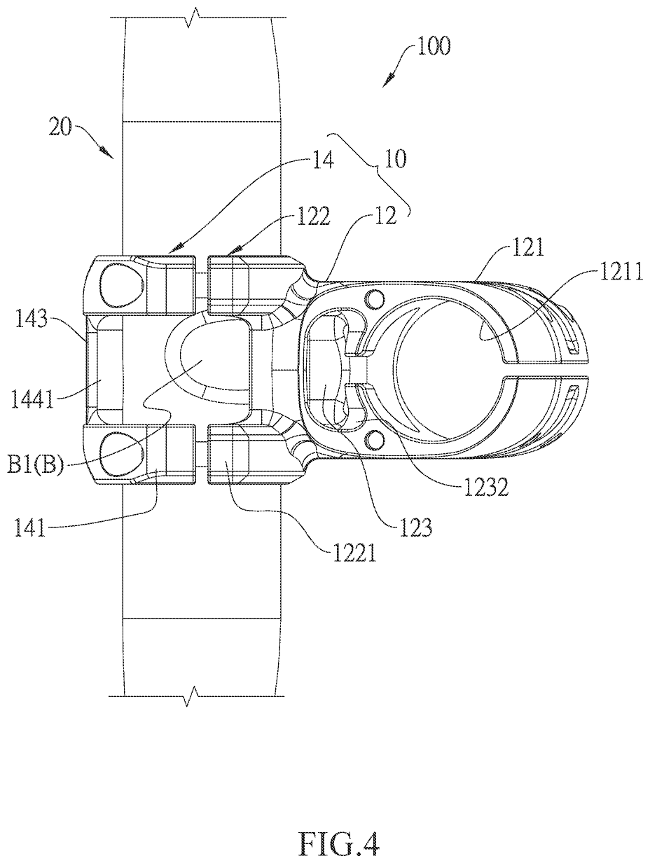

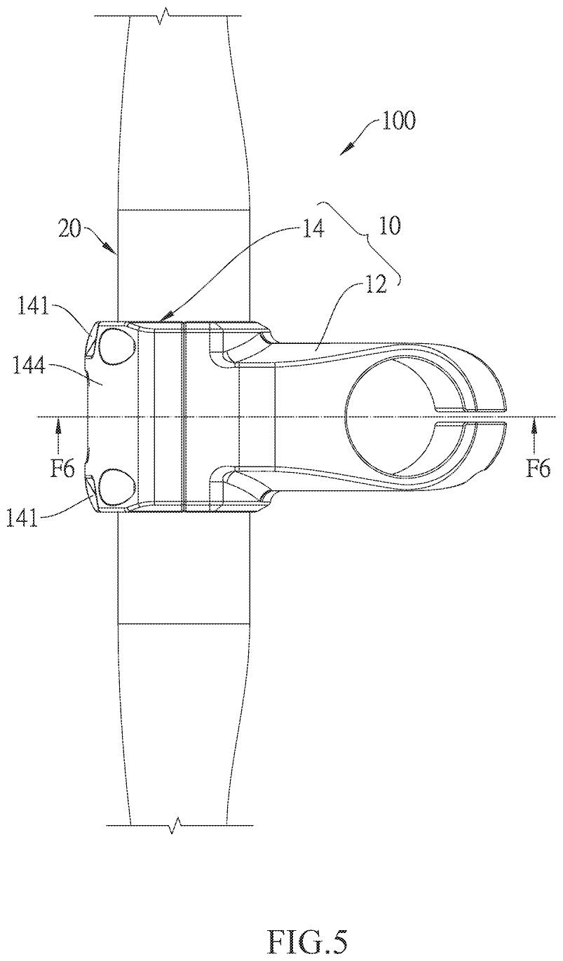

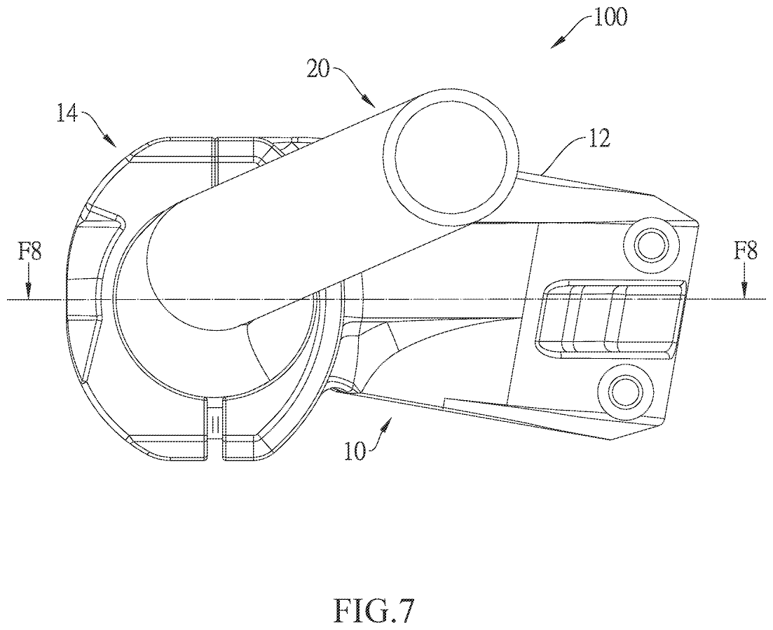

As shown in FIG. 2 to FIG. 8, the stem body 12 has a cable routing space 123 therein, wherein a position of the cable routing space 123 facing the handlebar connecting portion 122 has an entrance 1231, and a position of the cable routing space 123 adjacent to the fork connecting portion 121 has an exit 1232. More specifically, the exit 1232 is located on a second side of the stem body 12. Two opposite sides of the handlebar connecting portion 122 in a direction perpendicular to the first axial direction L1 respectively have a first clamping portion 1221. Each of the two first clamping portions 1221 is a C-shaped arm, wherein two opposite ends of each of the two first clamping portions 1221 respectively have an engaging hole base 1222. The entrance 1231 of the cable routing space 123 is formed on a part of the handlebar connecting portion 122 located between the two first clamping portions 1221.

The clamping member 14 is detachably engaged with the handlebar connecting portion 122 of the stem body 12. Two opposite sides of the clamping member 14 in the direction perpendicular to the first axial direction L1 respectively have a second clamping portion 141, wherein the two second clamping portions 141 are opposite to the two first clamping portions 1221 along the first axial direction L1. Each of the two second clamping portions 141 is a C-shaped arm, wherein two opposite ends of each of the two second clamping portions 141 respectively have a through hole base 1411. Preferably, a first distance H1 between the two second clamping portions 141 along the direction perpendicular to the first axial direction L1 is less than or equal to 100 mm.

In the first embodiment, the clamping member 14 is detachably engaged with the handlebar connecting portion 122 of the stem body 12 through screwing. When the clamping member 14 is engaged with the handlebar connecting portion 122, four screws 142 respectively pass through one of the through hole bases 1411 to be screwed on the engaging hole base 1222 for fixing. A part of the clamping member 14 located between the two second clamping portions 141 has an opening 143. A connecting portion 144 is connected between two first sides of the two second clamping portions 141. A top edge of the opening 143 is connected to a bottom edge of the connecting portion 144. An inside of the connecting portion 144 has a groove portion 1441. A distal end of the groove portion 1441 communicates with the opening 143. When the clamping member 14 is engaged with the handlebar connecting portion 122 of the stem body 12, a proximal end of the groove portion 1441 communicates with a first side of the entrance 1231 of the cable routing space 123, so that the groove portion 1441 is connected between the opening 143 of the clamping member 14 and the first side of the entrance 1231 of the cable routing space 123.

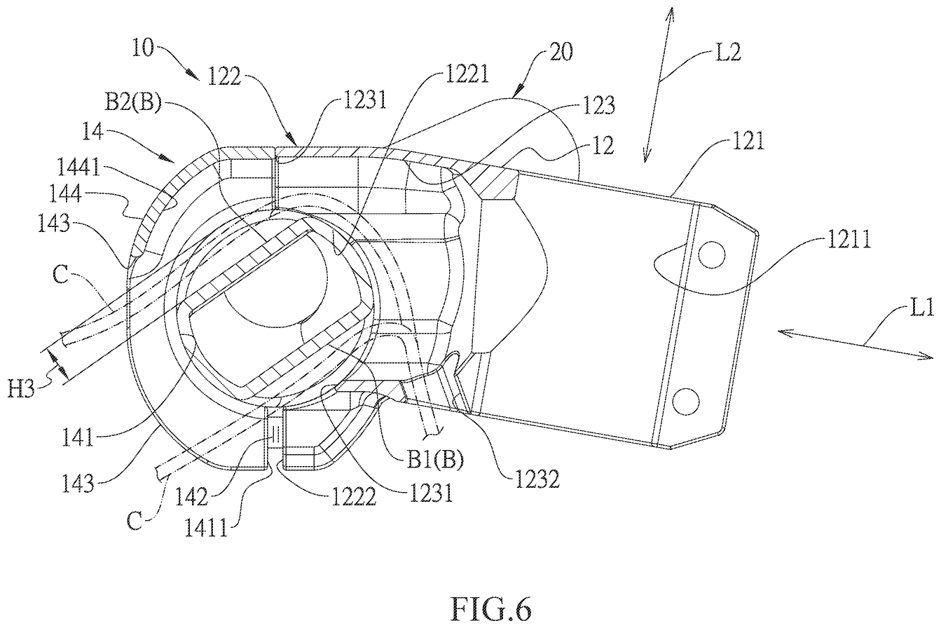

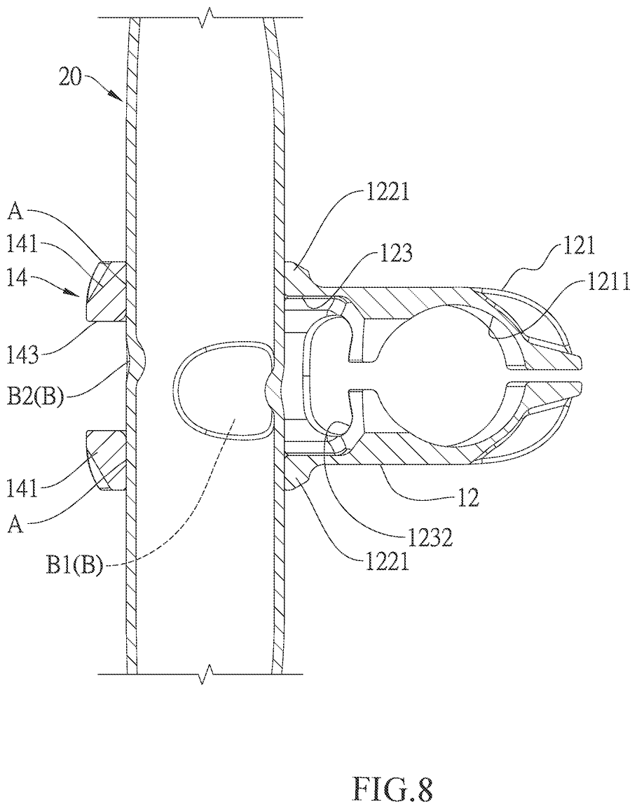

As shown in FIG. 2 to FIG. 4, FIG. 6, and FIG. 8, the handlebar 20 is clamped between the two first clamping portions 1221 of the handlebar connecting portion 122 and the two second clamping portions 141 of the clamping member 14 for fixing. Two parts of an outer surface of the handlebar 20, which are clamped between the two first clamping portions 1221 and the two second clamping portions 141, are defined as two clamped surfaces A. Preferably, a second distance H2 between the two clamped surfaces A along the third axial direction H is less than or equal to 40 mm. When the two clamped surfaces A of the handlebar 20 tightly abut against the two first clamping portions 1221 of the distal end of the stem body 12, an edge of a second side of the entrance 1231 of the cable routing space 123 is connected to the outer surface of the handlebar 20 located between the two clamped surfaces A, and an edge of the first side of the entrance 1231 of the cable routing space 123 is separated from the outer surface of the handlebar 20 located between the two clamped surfaces A.

A part of the handlebar 20 located between the two clamped surfaces A has two cable routing pathways B, wherein each of the cable routing pathways B communicates between the opening 143 of the clamping member 14 and the entrance 1231 of the cable routing space 123. Each of the cable routing pathways B is formed by recessing inward into the outer surface of the handlebar 20 and does not communicate with an inner portion of the handlebar 20. A third distance H3 between a deepest position of each of the cable routing pathways B that recess into the outer surface of the handlebar 20 and the outer surface of the handlebar 20 is greater than or equal to 2 mm, so that each of the cable routing pathways B has enough space for a cable C to pass through.

In the first embodiment, one of the two cable routing pathways B forms a second recess B1 on a second side of the handlebar 20 located between the two clamped surfaces A, wherein the second recess B1 communicates between the opening 143 of the clamping member 14 and the second side of the entrance 1231 of the cable routing space 123. The other cable routing pathway B forms a first recess B2 on a first side of the handlebar 20 located between the two clamped surfaces A, wherein the first recess B2 communicates between the opening 143 of the clamping member 14 and the first side of the entrance 1231 of the cable routing space 123. The first recess B2 communicates with the groove portion 1441 on the first side of the clamping member 14, so that a space, which is adapted to be passed through by the cable C, between the opening 143 of the clamping member 14 and the first side of the entrance 1231 of the cable routing space 123 is expanded. A width of the first recess B2 along the third axial direction H is smaller than a width between the two clamped surfaces A along the third axial direction H. A width of the second recess B1 along the third axial direction H is smaller than the width between the two clamped surfaces A along the third axial direction H. The first recess B2 and the second recess B1 are arranged in a staggered configuration in the third axial direction H.

In the first embodiment of the present disclosure, the two cable routing pathways B are formed on the handlebar 20. In other embodiments, only the first recess B2 could be formed on the first side of the handlebar 20 located between the two clamped surfaces A, or only the second recess B1 could be formed on the second side of the handlebar 20 located between the two clamped surfaces A; at that time, the width of the second recess B1 along the third axial direction H or the width of the first recess B2 along the third axial direction H could be equal to the width between the two clamped surface A along the third axial direction H, or the second recess B1 or the first recess B2 could be deepened, so that the first recess B2 or the second recess B1 could be adapted to be passed through by two or more cables C.

Referring to FIG. 1 to FIG. 3 and FIG. 6, when the first embodiment of the present disclosure is used, the fork connecting portion 121 of the stem body 12 clamps and fixes the steerer tube of the fork of the bicycle, and components, such as a brake lever or a gearshift lever, are installed on the handlebar 20. Cables C connected to the brake lever or cables connected to the gearshift lever respectively pass through the opening 143 and then the cable routing pathways B (i.e., either the second recess B1 or the first recess B2) of the handlebar 20 to enter the cable routing space 123 in the stem body 12 and afterward exit from the exit 1232, so that the cables C penetrate through the stem body 12 to be hidden in the stem body 12, thereby achieving the effect of routing the cables C within the stem 10 in a hidden manner. As two sides of the handlebar 20 having the cable routing pathways B are clamped by the two first clamping portions 1221 and the two second clamping portions 141, a middle of the handlebar 20 having the cable routing pathways B could be fixed without being easily deformed, so that the strength of the part of the handlebar 20 having the cable routing pathways B could be increased, thereby preventing the strength of the middle of the handlebar 20 from being decreased due to the configuration of the cable routing pathways B and preventing the middle of the handlebar 20 from being easily bent when external forces are applied on two ends of the handlebar 20.

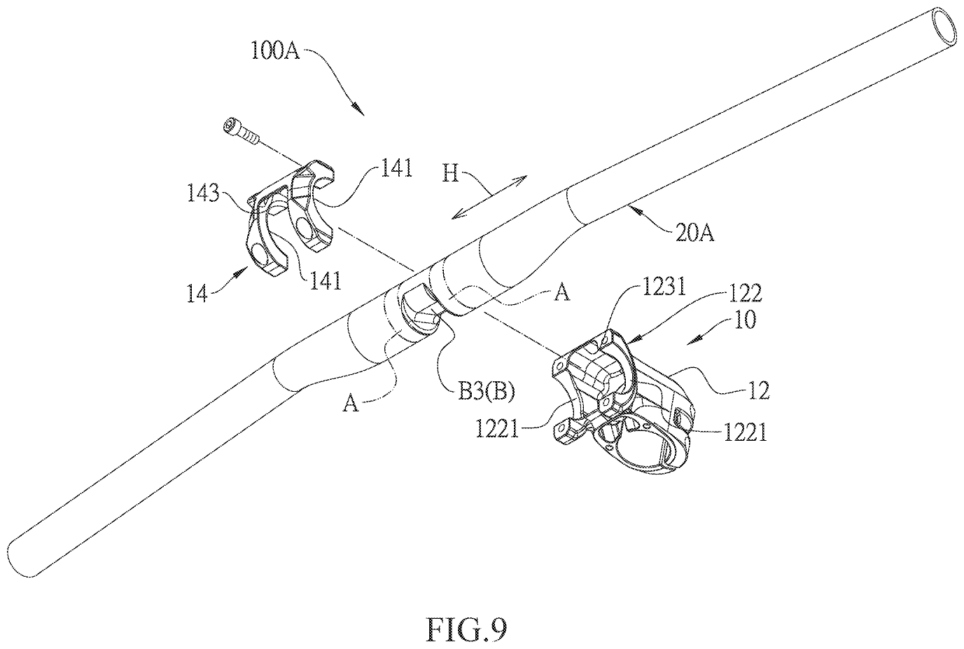

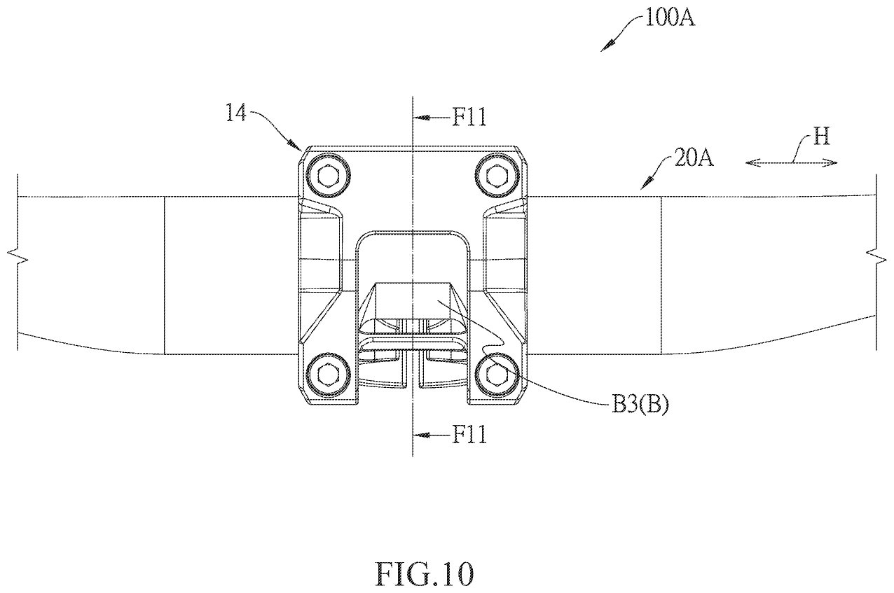

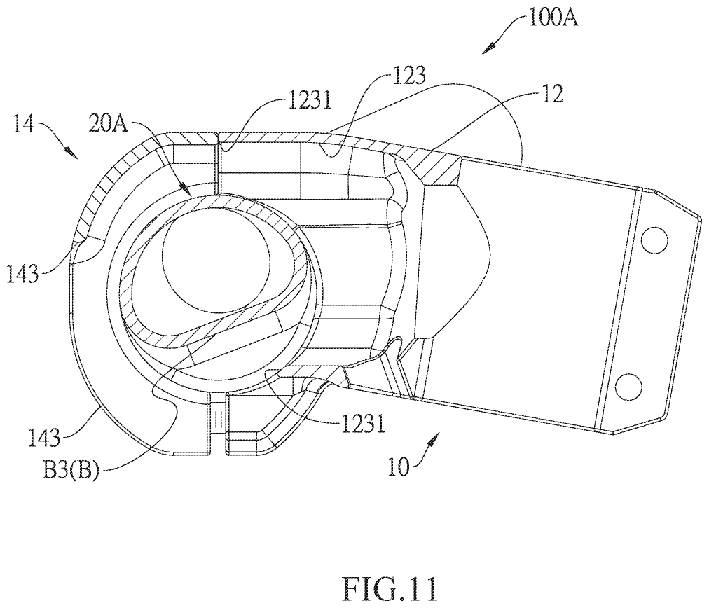

In addition to the first embodiment of the present disclosure, in which the second side and the first side of the handlebar 20 located between the two clamped surfaces A form the second recess B1 and the first recess B2, respectively, only one cable routing pathway B that is similar to the second recess B1 could be provided on the second side of the handlebar 20 located between the two clamped surfaces A. A bicycle handlebar system with a cable routing pathway 100A according to a second embodiment of the present disclosure is illustrated in FIG. 9 to FIG. 11 and includes a stem 10, which is the same as the stem 10 in the first embodiment, and a handlebar 20A engaged with the stem 10.

In the second embodiment, the handlebar 20A is similarly clamped between the two first clamping portions 1221 of the handlebar connecting portion 122 of the stem body 12 and the two second clamping portions 141 of the clamping member 14 for fixing. Two parts of an outer surface of the handlebar 20A, which are clamped between the two first clamping portions 1221 and the two second clamping portions 141, are defined as two clamped surfaces A. A part of the handlebar 20A located between the two clamped surfaces A has a cable routing pathway B, wherein the cable routing pathway B communicates between the opening 143 of the clamping member 14 and the entrance 1231 of the cable routing space 123. The cable routing pathway B is formed by recessing inward into the outer surface of the handlebar 20A and does not communicate with an inner portion of the handlebar 20A.

More specifically, the cable routing pathway B in the second embodiment forms a second recess B3 on a second side of the handlebar 20A located between the two clamped surfaces A, wherein the second recess B3 communicates between the opening 143 of the clamping member 14 and the second side of the entrance 1231 of the cable routing space 123 and is used for cable routing. A width of a widest position of the second recess B3 along the third axial direction H is equal to a width between the two clamped surfaces A along the third axial direction H. In other embodiments, the width of the widest position of the second recess B3 along the third axial direction H could also be less than the width between the two clamped surfaces A along the third axial direction H; preferably, a third distance between a deepest position of the second recess B3 recessing into the outer surface of the handlebar 20A and the outer surface of the handlebar 20A is greater or equal to 2 mm; preferably, a second distance between the two clamped surfaces A along the third axial direction H is less than or equal to 40 mm; preferably, a first distance between the two second clamping portions 141 along the third axial direction H is less than or equal to 100 mm.

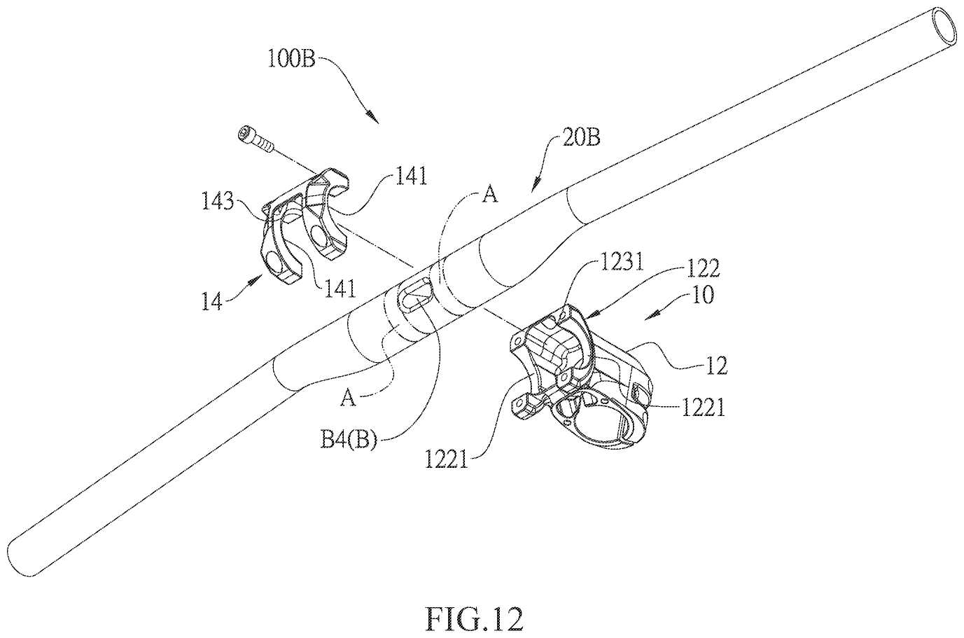

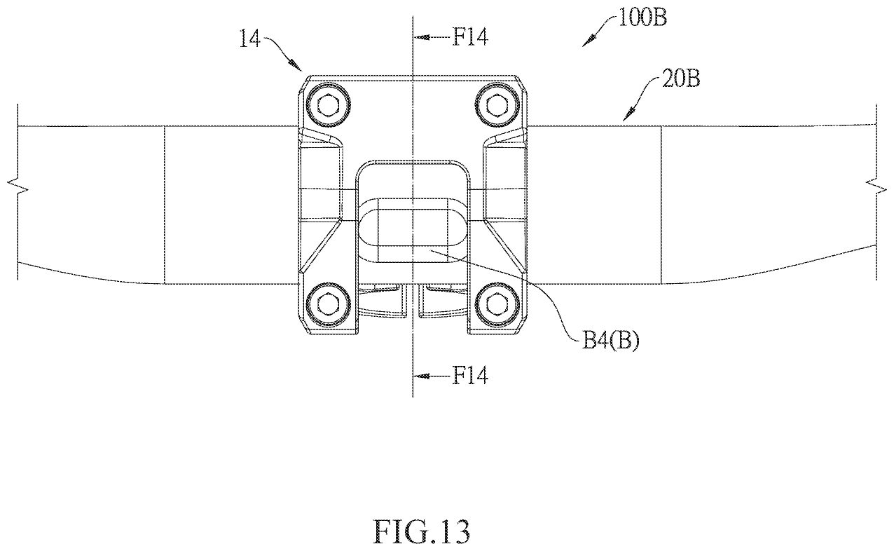

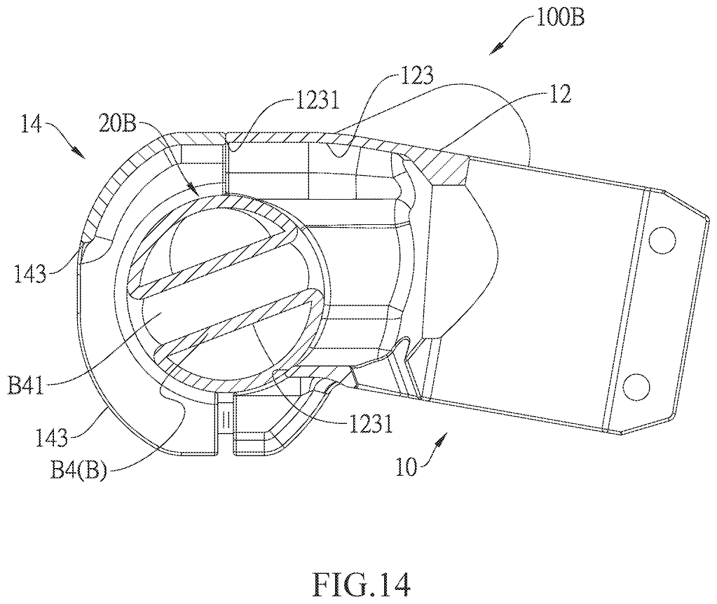

In addition to the first embodiment of the present disclosure, in which the second side and the first side of the handlebar 20 located between the two clamped surfaces A form the second recess B1 and the first recess B2, respectively, a passageway communicating between two opposite sides of the outer surface of the handlebar 20 could be formed on the part of the handlebar 20 located between the two clamped surfaces A and is used for cable routing. A bicycle handlebar system with a cable routing pathway 100B according to a third embodiment of the present disclosure is illustrated in FIG. 12 to FIG. 14 and includes a stem 10, which is the same as the stem 10 in the first embodiment, and a handlebar 20B engaged with the stem 10.

In the third embodiment, the handlebar 20B is similarly clamped between the two first clamping portions 1221 of the handlebar connecting portion 122 of the stem body 12 and the two second clamping portions 141 of the clamping member 14 for fixing. Two parts of an outer surface of the handlebar 20B, which are clamped between the two first clamping portions 1221 and the two second clamping portions 141, are defined as two clamped surfaces A. A part of the handlebar 20B located between the two clamped surfaces A has a cable routing pathway B, wherein the cable routing pathway B communicates between the opening 143 of the clamping member 14 and the entrance 1231 of the cable routing space 123. The cable routing pathway B is formed by recessing inward into the outer surface of the handlebar 20B and does not communicate with an inner portion of the handlebar 20B. More specifically, in the third embodiment, the cable routing pathway B is a tubing section B4 connected between two opposite sides of the part of the handlebar 20B located between the two clamped surfaces A, wherein a through hole B41 penetrating through two opposite sides of the outer surface of the handlebar 20B is formed in the tubing section B4 and communicates between the opening 143 of the clamping member 14 and the entrance 1231 of the cable routing space 123 and is used for cable routing.

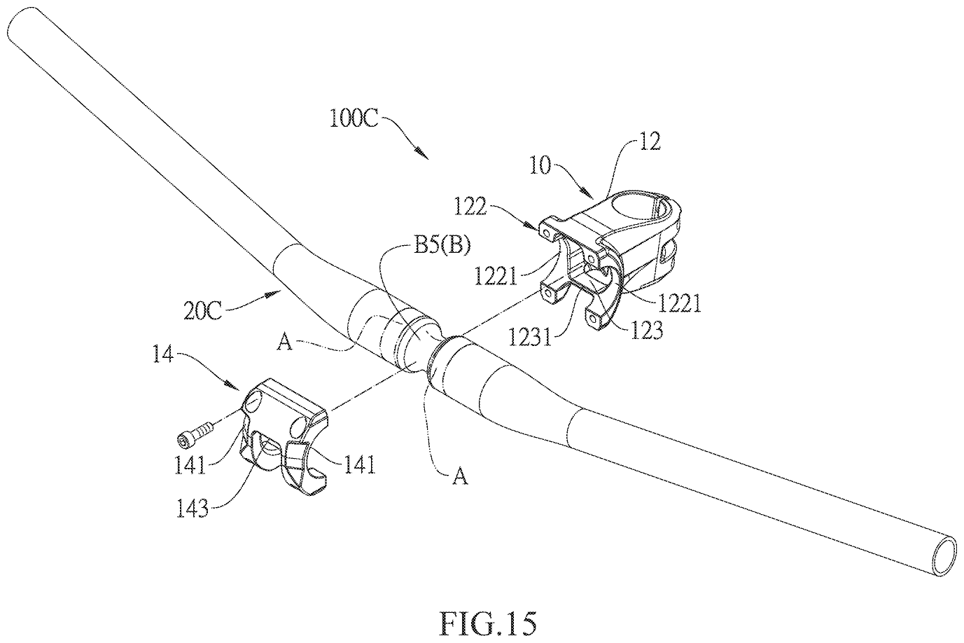

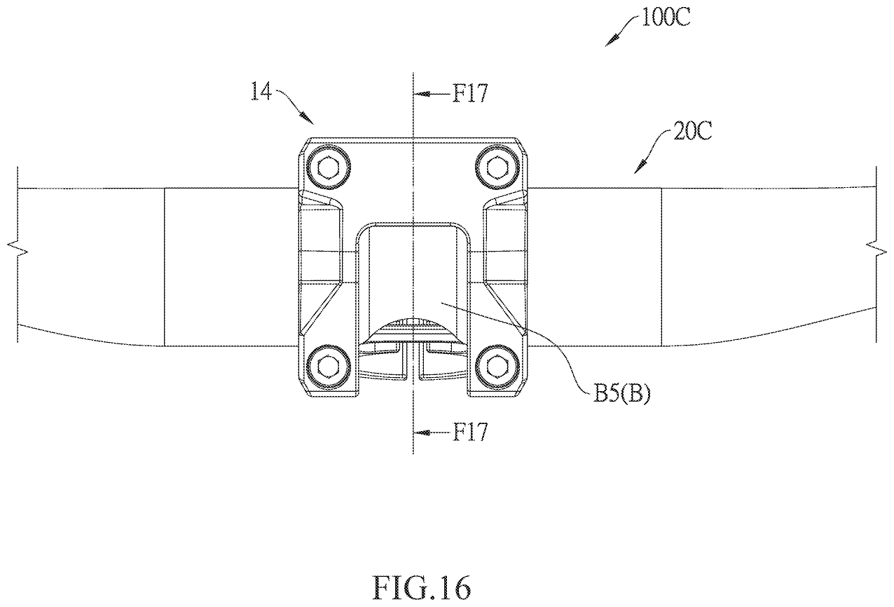

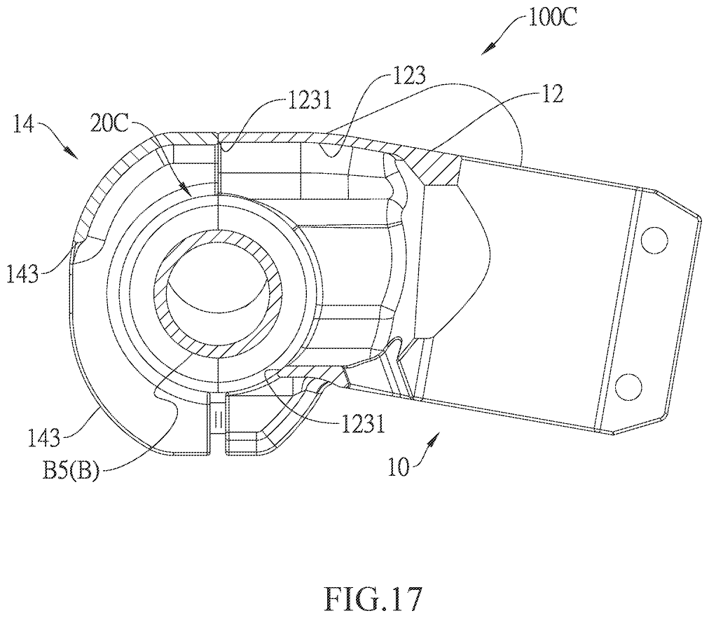

In addition to the first embodiment of the present disclosure, in which the second side and the first side of the handlebar 20 located between the two clamped surfaces A form the second recess B1 and the first recess B2, respectively, only one cable routing pathway B could be formed on a peripheral side of the part of the handlebar 20 located between the two clamped surfaces A for cable routing. A bicycle handlebar system with a cable routing pathway 100C according to a fourth embodiment of the present disclosure is illustrated in FIG. 15 to FIG. 17 and includes a stem 10, which is the same as the stem 10 in the first embodiment, and a handlebar 20C engaged with the stem 10.

In the fourth embodiment, the handlebar 20C is similarly clamped between the two first clamping portions 1221 of the handlebar connecting portion 122 of the stem body 12 and the two second clamping portions 141 of the clamping member 14 for fixing. Two parts of an outer surface of the handlebar 20C, which are clamped between the two first clamping portions 1221 and the two second clamping portions 141, are defined as two clamped surfaces A. A part of the handlebar 20C located between the two clamped surfaces A has a cable routing pathway B, wherein the cable routing pathway B communicates between the opening 143 of the clamping member 14 and the entrance 1231 of the cable routing space 123. The cable routing pathway B is formed by recessing inward into the outer surface of the handlebar 20C, and does not communicate with an inner portion of the handlebar 20C. More specifically, in the fourth embodiment, the cable routing pathway B is a annular groove B5 formed by recessing inward into the outer surface of the handlebar 20C located between the two clamped surfaces A, wherein the annular groove B5 communicates between the opening 143 of the clamping member 14 and the entrance 1231 of the cable routing space 123 and is used for cable routing.

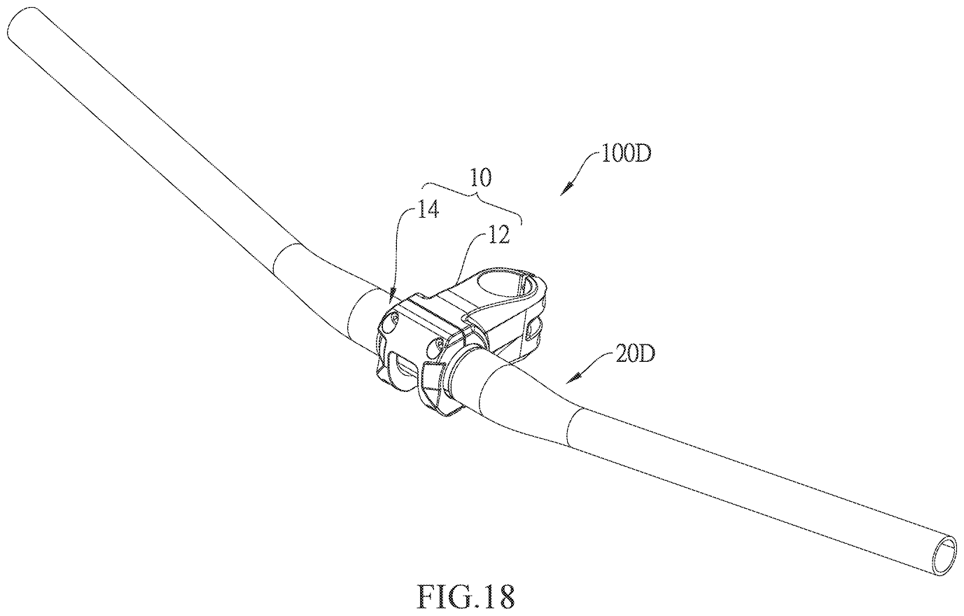

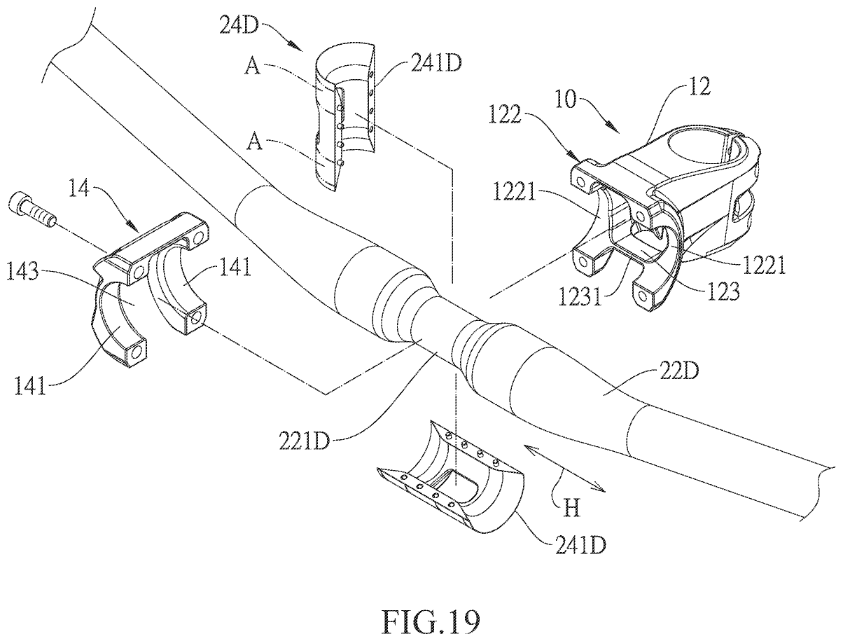

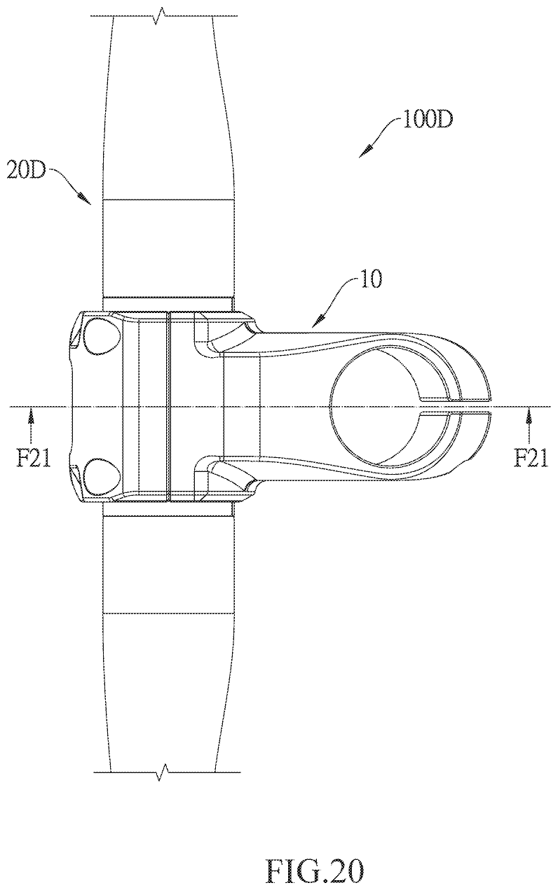

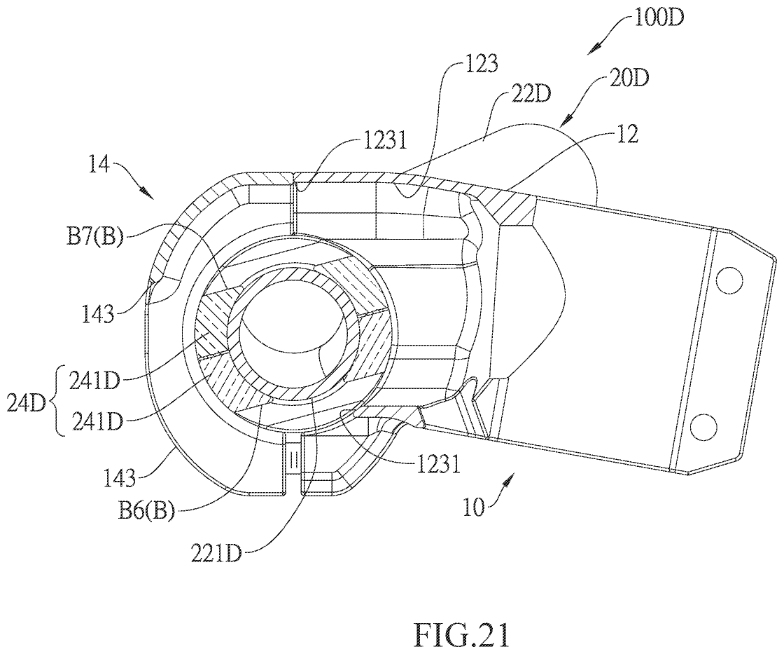

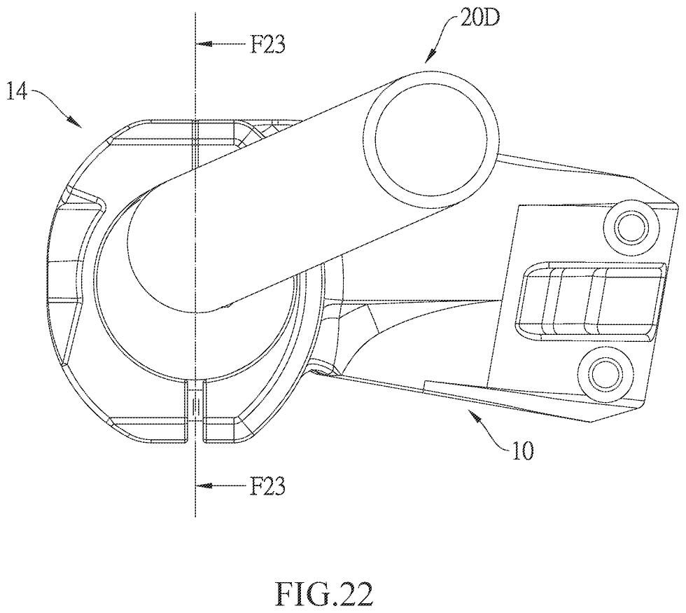

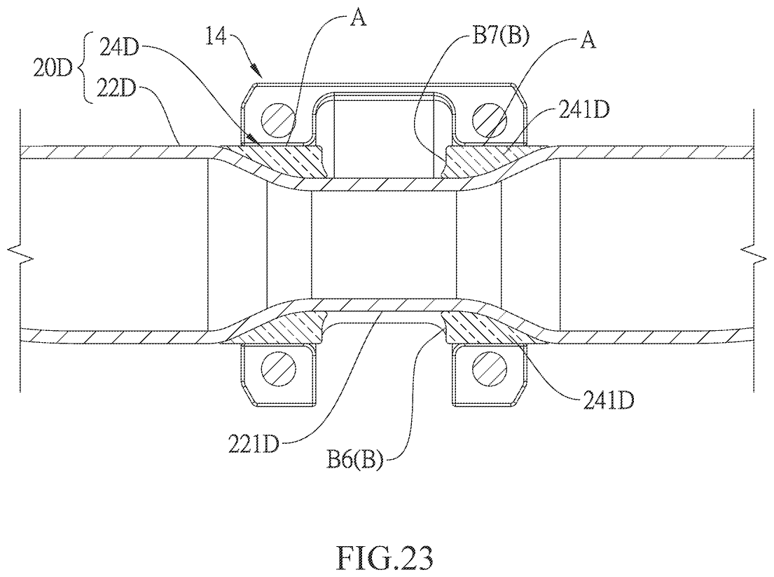

In addition to the first embodiment of the present disclosure, in which the handlebar 20 is formed as a monolithic unit, handlebar 20 could be a handlebar device formed by engaging a plurality of components. A bicycle handlebar system with a cable routing pathway 100D according to a fifth embodiment of the present disclosure is illustrated in FIG. 18 to FIG. 23 and includes a stem 10, which is the same as the stem 10 in the first embodiment, and a handlebar 20D engaged with the stem 10.

In the fifth embodiment, the handlebar 20D includes a handlebar body 22D and a bushing 24D. A middle of the handlebar body 22D forms a small-diameter portion 221D, wherein a length of the small-diameter portion 221D along the third axial direction H is equal to a length of the of the handlebar connecting portion 122 along the third axial direction H and is equal to a length of the clamping member 14 along third axial direction H. An outer diameter of the small-diameter portion 221D is less than a boundary surrounded by each of the first clamping portions 1221 and each of the second clamping portions 141.

The bushing 24D includes two half casings 241D that are engaged with each other. The bushing 24D fits around the small-diameter portion 221D of the handlebar body 22D, wherein an outer surface of the bushing 24D is aligned with an outer surface of two opposite sides of the handlebar body 22D adjacent to two ends of the small-diameter portion 221D. The bushing 24D of the handlebar 20D is clamped between the two first clamping portions 1221 of the handlebar connecting portion 122 of the stem body 12 and the two second clamping portions 141 of the clamping member 14 for fixing. Two parts of the outer surface of the bushing 24D, which are clamped between the two first clamping portions 1221 and the two second clamping portions 141, are defined as two clamped surfaces A. A part of the handlebar 20C located between the two clamped surfaces A, i.e., a part of the bushing 24D located between the two clamped surfaces A, has two cable routing pathways B, wherein the two cable routing pathways B are formed by recessing inward into the outer surface of the bushing 24D and do not communicate with an inner portion of the handlebar body 22D. Each of the cable routing pathways B communicates between the opening 143 of the clamping member 14 and the entrance 1231 of the cable routing space 123.

More specifically, in the fifth embodiment, one of the two cable routing pathways B is a second recess B6 formed by recessing into the outer surface of one of the half casings 241D located between the two clamped surfaces A, the other cable routing pathway B is a first recess B7 formed by recessing into the outer surface of the other half casing 241D located between the two clamped surface A. The second recess B6 and the first recess B7 of the bushing 24D respectively communicate between the opening 143 of the clamping member 14 and the entrance 1231 of the cable routing space 123 and are used for cable routing. Thus, when the stem 10 is engaged with a steerer tube of a fork, cables of a brake lever or cables of a gearshift lever could pass through the inside of the stem 10 to be hidden, thereby achieving the effect of routing the cables in a hidden manner. The two first clamping portions 1221 and the two second clamping portions 141 fit around the two clamped surfaces A and the bushing 24D formed by the two-half casing 241D compresses around the small-diameter portion 221D for fixing, so that a middle of the handlebar 20D could be fixed without being easily bent, and the strength of the part of the handlebar 20D having the two cable routing pathways B could be increased, thereby achieving the effect of preventing the handlebar 20D from being easily bent when two ends of the handlebar 20D are subjected to forces.

It must be pointed out that the embodiments described above are only some preferred embodiments of the present disclosure. All equivalent structures which employ the concepts disclosed in this specification and the appended claims should fall within the scope of the present disclosure.

What is claimed is:

1. A bicycle handlebar system with a cable routing pathway, comprising a stem and a handlebar engaged with the stem; the stem extends along a first axial direction; two opposite ends of the first axial direction are respectively defined as a distal end and a proximal end;
wherein the stem comprises a stem body and a clamping member; a proximal end of the stem body has a fork connecting portion; a distal end of the stem body has a handlebar connecting portion; the stem body has a cable routing space therein, wherein a position of the cable routing space facing the handlebar connecting portion has an entrance, and a position of the cable routing space adjacent to the fork connecting portion has an exit; two opposite sides of the handlebar connecting portion in a direction perpendicular to the first axial direction respectively have a first clamping portion; the entrance is formed between the two first clamping portions; the clamping member is detachably engaged with the handlebar connecting portion; two opposite sides of the clamping member in the direction perpendicular to the first axial direction respectively have a second clamping portion; the two second clamping portions are opposite to the two first clamping portions in the first axial direction; a part of the clamping member located between the two second clamping portions has an opening;
the handlebar is clamped between the handlebar connecting portion and the clamping member for fixing; two parts of an outer surface of the handle, which are clamped between the two first clamping portions and the two second clamping portions, are defined as two clamped surfaces; a part of the handlebar located between the two clamped surfaces has at least one cable routing pathway, wherein the at least one cable routing pathway communicates between the opening and the entrance.

2. The bicycle handlebar system with the cable routing pathway as claimed in claim 1, wherein the fork connecting portion has a fork connecting hole; the fork connecting hole extends along a second axial direction; two opposite sides of the second axial direction are respectively defined as a first side and a second side; an edge of a second side of the entrance is connected to the outer surface of the handlebar located between the two clamped surfaces; an edge of a first side of the entrance and the outer surface of the handlebar located between the two clamped surfaces are spaced.

3. The bicycle handlebar system with the cable routing pathway as claimed in claim 2, wherein a connecting portion is connected between two first sides of the two second clamping portions; an inside of the connecting portion has a groove portion, wherein a distal end of the groove portion communicates with the opening, and a proximal end of the groove portion communicates with the first side of the entrance of the cable routing space.

4. The bicycle handlebar system with the cable routing pathway as claimed in claim 1, wherein the fork connecting portion has a fork connecting hole; the fork connecting hole extends along a second axial direction; two opposite sides of the second axial direction are respectively defined as a first side and a second side; the at least one cable routing pathway comprises a cable routing pathway; the cable routing pathway forms a second recess on a second side of the handlebar located between the two clamped surfaces, wherein the second recess communicates between the opening and a second side of the entrance.

5. The bicycle handlebar system with the cable routing pathway as claimed in claim 4, wherein the handlebar has another cable routing pathway; the another cable routing pathway forms a first recess on a first side of the handlebar located between the two clamped surfaces, wherein the first recess communicates between the opening and a first side of the entrance.

6. The bicycle handlebar system with the cable routing pathway as claimed in claim 5, wherein the handlebar extends along a third axial direction; a width of the first recess along the third axial direction is smaller than a width between the two clamped surfaces along the third axial direction; a width of the second recess along the third axial direction is smaller than the width between the two clamped surfaces along the third axial direction; the first recess and the second recess are arranged in a staggered configuration in the third axial direction.

7. The bicycle handlebar system with the cable routing pathway as claimed in claim 1, wherein the fork connecting portion has a fork connecting hole; the fork connecting hole extends along a second axial direction; two opposite sides of the second axial direction are respectively defined as a first side and a second side; the at least one cable routing pathway comprises a cable routing pathway; the cable routing pathway comprises a tubing section connected between two opposite sides of a part of the handlebar located between two clamped surfaces, wherein a through hole is formed in the tubing section.

8. The bicycle handlebar system with the cable routing pathway as claimed in claim 1, wherein the fork connecting portion has a fork connecting hole; the fork connecting hole extends along a second axial direction; two opposite sides of the second axial direction are respectively defined as a first side and a second side; the at least one cable routing pathway comprises a cable routing pathway; the cable routing pathway is an annular groove formed by recessing inward into the outer surface of the handlebar located between the two clamped surfaces.

9. The bicycle handlebar system with the cable routing pathway as claimed in claim 1, wherein the handlebar comprises a handlebar body and a bushing; a middle of the handlebar body forms a small-diameter portion, wherein an outer diameter of the small-diameter portion is smaller than a boundary surrounded by each of the two first clamping portions and each of the two second clamping portions; the bushing fits around the small-diameter portion, wherein an outer surface of the bushing is aligned with an outer surface of two opposite sides of the handlebar body adjacent to two ends of the small-diameter portion; the two clamped surfaces are formed on the outer surface of the bushing; the at least one cable routing pathway is formed on the bushing.

10. The bicycle handlebar system with the cable routing pathway as claimed in claim 9, wherein the bushing comprises two half casings that are engaged with each other; the at least one cable routing pathway comprises two cable routing pathways; one of the two cable routing pathways forms a first recess on one of the two half casings, the other cable routing pathway forms a second recess on the other half casing.

11. The bicycle handlebar system with the cable routing pathway as claimed in claim 1, wherein the at least one cable routing pathway is formed by recessing inward into the outer surface of the handlebar and does not communicate with an inner portion of the handle.

12. The bicycle handlebar system with the cable routing pathway as claimed in claim 1, wherein a third distance between a deepest position of the at least one cable routing pathway recessing into the outer surface of the handlebar and the outer surface of the handlebar is greater than or equal to 2 mm.

13. The bicycle handlebar system with the cable routing pathway as claimed in claim 1, wherein a first distance between the two second clamping portions along the direction perpendicular to the first axial direction is less than or equal to 100 mm.

14. The bicycle handlebar system with the cable routing pathway as claimed in claim 1, wherein the handlebar extends along a third axial direction; a second distance between the two clamped surfaces along the third axial direction is less than or equal to 40 mm.

15. The bicycle handlebar system with the cable routing pathway as claimed in claim 1, wherein the at least one cable routing pathway comprises at least two cable routing pathways.
